(19) United States
(12) Patent Application Publication
(10) Pub. No.: US 2014/0032743 A1
(43) Pub. Date: Jan. 30, 2014

(54) SELECTING EQUIPMENT ASSOCIATED WITH PROVIDER ENTITIES FOR A CLIENT REQUEST

(71) Applicants: James S. Hiscock, Rockport, MA (US); Paul T. Congdon, Granite Bay, CA (US)

(72) Inventors: James S. Hiscock, Rockport, MA (US); Paul T. Congdon, Granite Bay, CA (US)

(21) Appl. No.: 13/561,593

(22) Filed: Jul. 30, 2012

(51) Int. Cl. G06F 15/16

(52) U.S. Cl. 709/224

(57) ABSTRACT

In response to a request of a client device, an intermediary system selects from among equipment associated with respective provider entities, where the selecting is based on habitual information associated with a user of the client device. A task of the request is caused to be performed on the selected equipment.

### BACKGROUND

With the proliferation of mobile devices, such as notebook computers, tablet computers, personal digital assistants (PDAs), smartphones, and so forth, users are able to perform computing tasks wherever they travel. Additionally, a user can also be associated with multiple electronic devices, for use in different contexts (e.g. for use at work, for personal use, and so forth). In different contexts, users can perform different tasks.

### BRIEF DESCRIPTION OF THE DRAWINGS

Some embodiments are described with respect to the following figures:

FIG. 1 is a block diagram of an example arrangement, in accordance with some implementations;

FIG. 2 is a flow diagram of a process according to some implementations;

FIGS. 3 and 4 are block diagrams of further example arrangements, in accordance with further implementations;

FIG. 5 depicts example content of an interaction log, useable according to some implementations;

FIG. 6 depicts example content of a habit list, useable according to some implementations; and

FIG. 7 is a block diagram of an interaction system according to some implementations.

### DETAILED DESCRIPTION

Using one or multiple electronic devices, a user can perform various different tasks. Examples of electronic devices include a desktop computer, a notebook computer, a tablet computer, a personal digital assistant (PDA), a smartphone, a game appliance, and so forth. A user can be associated with a personal grid, which can include multiple electronic devices that can be used by the user. Content can be shared across the multiple electronic devices of the personal grid.

In some examples, a user can roam between different geographic locations. As the user moves to different geographic locations, it may be desirable to leverage equipment that may be available at the different locations to perform tasks requested by the user. Examples of equipment can include any of the following: a display device, an audio player, a computer, and so forth. A further example of equipment can include a network communication infrastructure to allow access of a network connection, such as a wired connection or wireless connection (e.g. WiFi hotspot, Bluetooth wireless connection, cellular access network, etc.). As a user moves between different locations, different equipment may become available to perform tasks requested by the user.

The devices or network communication infrastructure available at different locations may be owned by different external provider entities. An external provider entity refers to any person (individual or organization) that owns, manages, or operates respective equipment, such as display devices, audio players, computers, network communication devices, and so forth. The external provider entity is distinct from the user.

Equipment owned or managed by an external provider entity is referred to as “external provider equipment” in the ensuing discussion.

The different devices and network communication infrastructure of external provider equipment can be associated with different protocols and different access mechanisms (e.g. authentication and authorization mechanisms). The different protocols can refer to different protocols used to interact or communicate with the external provider equipment. The authentication and authorization mechanisms are used to determine whether a user is a trusted user and is authorized to access the requested functions at the external provider equipment.

It may be relatively difficult or complex for a client device (belonging to a user) to discover external provider equipment, at various different locations, that the user may use to perform a given task. Moreover, it can be difficult or complex for the client device to understand access mechanisms and/or protocols for accessing functions of the external provider equipment. Since a user may potentially roam to any of many different geographic locations, there can potentially be a relatively very large number of external provider equipment that would have to be discovered by a client device to allow the client device to access such external provider equipment for performing client tasks. Note also that the geographic locations to which a user may roam may not be known a priori. In some cases, a user may travel to an unplanned location or new location that the user has not previously visited.

Different external provider equipment can also be associated with different user interfaces, some of which may be unfamiliar to a user. When presented with an unfamiliar user interface to access functions of external provider equipment, the user may make incorrect inputs, or may simply give up if the user is unable to understand the user interface.

In accordance with some implementations, an intermediary system is provided to allow for ease of selecting external provider equipment associated with different provider entities for performing tasks associated with a given electronic device (referred to hereinafter as a “client device”) of a user. The intermediary system can present the user with a familiar (common) user interface, having control items (e.g. control menus, control icons, etc.) and having a format and look-and-feel that the user recognizes. As a result, the user would not have to learn unfamiliar user interfaces of external provider equipment provided by different provider entities. Instead, the intermediary system can allow the user to concentrate on completing a given task that is desired by the user.

The intermediary system can also obtain information regarding protocols and/or access mechanisms used by external provider equipment of different external provider entities. The obtained information can include any combination of the following: operational information or instructions on how to use the external provider equipment; credentials to use to obtain trusted access of the external provider equipment; location information to decide which external provider equipment is optimal to use to accomplish a target task; and other information. In some implementations, the obtained information can be part of agreements established between a service provider of the intermediary system and respective external provider entities. Further details regarding establishing agreements are described in a U.S. Application entitled “PROVIDING AGREEMENT INFORMATION TO ALLOW ACCESS BY A CLIENT DEVICE OF SELECTED EQUIPMENT FROM AMONG MULTIPLE EQUIPMENT,” (Attorney Docket No. 83016732), filed concurrently herewith.

The obtained information allows the intermediary system to easily and quickly grant access of functions of external provider equipment to a client device. Based on a request (and a context associated with the request), the intermediary system can automatically select from among different external provider equipment associated with respective provider entities to allow a task requested by the user to complete. The selected external provider equipment can include one or multiple devices to perform various functions, including a display function (to display content), an audio play function (to play audio), a processing function (to perform processing, such as by a computer), and so forth. The selected external provider equipment can also include a network communication infrastructure to allow the client device to make a network connection to communicate over a network.

The intermediary system effectively bridges the gap between mechanisms (e.g. user interfaces, protocols, and access mechanisms) of external entity equipment and familiar mechanisms of client device. For example, if a user wants to display or play a file that may contain music, pictures, video, or text, then the intermediary system can select a display device or other output device (owned by an external operator entity) in the proximity of the user to display or play the file. The intermediary system can also select any network connection to use for accessing the display device or other output device, where the network connection can also be owned by an external operator entity. The task (display or play the file) requested by the user can thus be performed using the selected device and network connection, without the user (or the client device of the user) having to learn the protocols and access mechanisms associated with the devices and network connections owned by the external provider entities.

As further examples, the intermediary system can also read files resident on client device(s) as well as devices of external provider entities. The user interface provided by the intermediary system enables the user to search for a file (or files) on which a target task is to be performed. Search results can be presented in the user interface, where the user can select the file on which the target task is to be performed. Additionally, from the user interface, the user can accept or reject external equipment selections made by the intermediary system. In addition, the intermediary system can utilize an external entity equipment as an input/output device to provide output and feedback to a user or to receive input from a client device.

In accordance with some implementations, the intermediary system is able to use habitual information of a user to select from among external provider equipment for performing a target task requested by the user. “Habitual information” refers to information determined based on previous interactions of the user, which can involve performance of the target task or a similar task. Such previous interactions indicate a habit of the user, which can be used to deduce which external provider equipment may be preferred by the user to perform the target task. The previous interactions can also include environmental information obtained from sensors in the user's client devices (e.g. GPS location information, information pertaining to strength of WiFi signals, information pertaining to a cellular connection, compass readings, magnetic field readings, etc.). This environmental information along with the set of activities a user participates in helps to determine a context of the user and habits that the user is possibly participating in or requesting.

Also, the habitual information can be based on an agreement (either a current agreement or a previous agreement) that involves the user, such as an agreement between the user and the service provider of the intermediary system. Habitual information may further be based on user preferences (e.g. preferences regarding how an image or video is to be displayed, preferences regarding characteristics of devices for outputting content, etc.).

In a specific example, if a user has been using a particular technique of displaying multimedia content in the past, then when the user wants to display multimedia content on an external provider display device, then the intermediary system can use the user's habitual information (based on the particular technique of displaying multimedia content in the past) to select an appropriate external provider display device from among multiple available external provider display devices to present the multimedia content. Additionally, once an external provider display device has been selected, the intermediary system can further select appropriate action(s) to perform for displaying the multimedia content based on the habitual information. For example, the selected action(s) can include a file conversion action, a formatting action, and so forth.

Generally, the intermediary system can be considered an agile task and communication broker, who can select external provider equipment to use, and deduce action(s) to take, to allow a user to accomplish a target task, quickly and with the simplicity that comes from utilizing familiar techniques which have become routine habits of the user. The intermediary system is able to interface external provider equipment using respective protocols and access mechanisms, and is able to translate a client request into action(s) to be applied in connection with the selected external provider equipment.

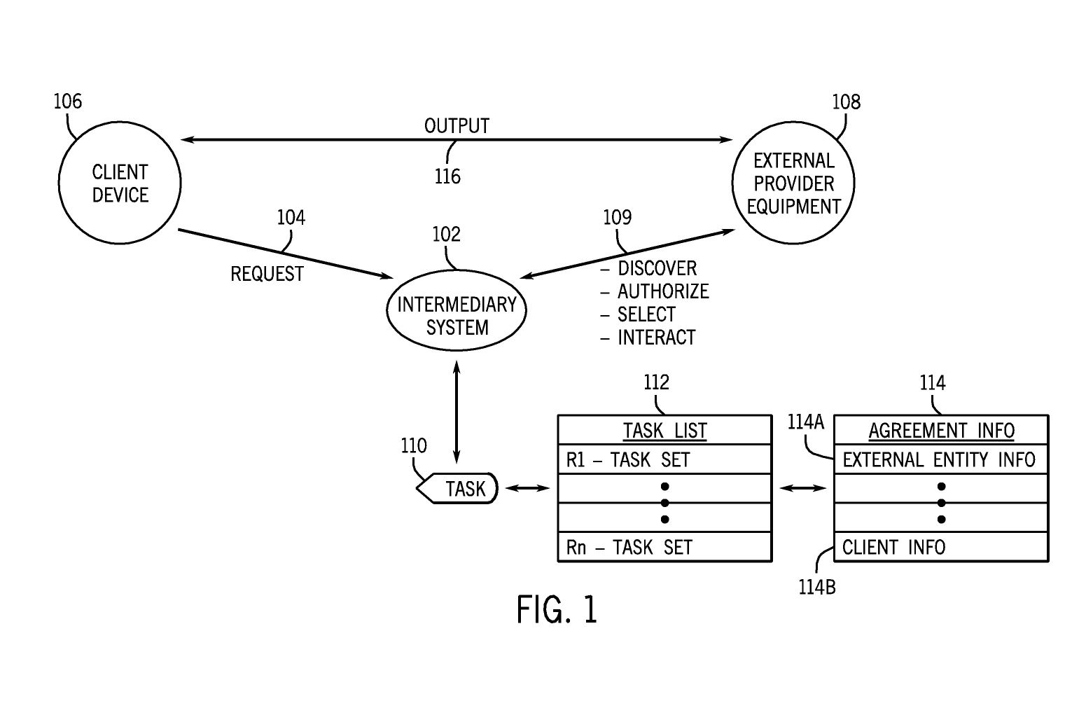

FIG. 1 depicts an example arrangement that includes an intermediary system 102 that is able to receive a request (104) from a client device 106, which can be associated with a user. FIG. 1 also depicts external provider equipment 108 (associated with respective external entity providers) that can be discovered by the intermediary system 102. The intermediary system 102 can include a computer system and any associated intermediary infrastructure (e.g. storage subsystem, communication subsystem, etc.) at a particular location, or alternatively, the intermediary system 102 can include a distributed arrangement of computer systems and associated intermediary infrastructure at multiple different locations distributed across any geographic region, such as a city, state, country, or the entire world.

The request (104) received by the intermediary system 102 can be an explicit request provided by the client device 106, or alternatively the request can be deduced by the intermediary system 102. The intermediary system 102 associates the request with a task (110). The task 110 can be represented by a task list 112 (or another type of task data structure). The intermediary system 102 can store or have access to multiple task lists 112, which are associated with different task sets. Once the task (110) is associated with the received request (104), the intermediary system 102 is able to access the task list 112 to determine the sub-tasks, which together make up the task (110).

The task list 112 depicted in FIG. 1 can include task sets identified as R1, . . . , Rn, respectively. The task sets in the task list 112 correspond to respective sub-tasks of the task (110) specified by the request (104). For example, if the task (110) is to present content of a file, then the sub-tasks can include the following: find the file, set up a network connection to retrieve the file, find a display device to display the file, and so forth. The intermediary system 102 would perform the sub-tasks of the task (110) that is specified by the request (104).

FIG. 1 further depicts agreement information 114 that is accessible by or is stored by the intermediary system 102. The agreement information 114 can include information 114A based on agreements established between a service provider of the intermediary system 102 and the external operator entities that are associated with the respective external provider equipment 108. In the ensuing discussion, this service provider is referred to as an “intermediary service provider.” Additionally, the agreement information 114 can include information 1148 based on an agreement established between the intermediary service provider and the user of the client device 106.

The information associated with the task sets in the task list 112, along with agreement information 114, can be used by the intermediary system 102 to (at 109) discover external provider equipment, perform authentication with respect to the external provider equipment (to allow access by the intermediary system of the discovered external provider equipment), select from among external provider equipment to use for the task sets, and interact with the selected external provider equipment to perform the task sets. Note that the task sets can be performed on the selected external provider equipment as well as on client device(s) of the personal grid of the user.

Performance of the task sets of the task (110) at the selected external provider equipment may produce an output (116), which can be sent from the external provider equipment 108 to the client device 106. Such output can provide feedback on the progress of the requested task, for example. In other examples, the output can further include other information to be provided to the user.

In a specific example, a user has traveled to a location of a monthly status meeting (“meeting event”) to present the user's project status. This meeting event can be stored in a calendar application of the client device 106. The intermediary system 102 may have access to information of the calendar application, and thus is aware of the scheduled meeting event. When the intermediary system 102 determines that the meeting is to start within some predefined amount of time (e.g. in 30 minutes), the intermediary system 102 can deduce a request (referred to as a “meeting request”) relating to this meeting event, where the request is deduced from information in the schedule provided by the calendar application.

The meeting request is associated with a meeting task. The intermediary system 102 then retrieves the corresponding task list 112 associated with the meeting task. In doing so, the intermediary system 102 has translated the deduced request to a collection of sub-tasks (retrieved from the task list 112) associated with the meeting task. In this example, the sub-tasks of the meeting task can include the following: provide a meeting warning to the user; present a map of a location of the meeting; show the location of the meeting room to the user; display a presentation file at a display device in the meeting room; and so forth.

Some of the sub-tasks of the meeting task can further be divided into further sub-tasks. For example, presenting the map can be broken down into the following further sub-tasks: retrieve building map; identify user's current location; modify map to indicate user's current location; and send the modified map to the client device 106. The collection of sub-tasks may re-iterate in a loop to progressively update certain information, such as updating the map with the user's current location. As another example, the task of displaying a presentation file at a display device in the meeting room may be broken down into the following further sub-tasks: check the location of presentation file; identify the location of the display device; perform authentication and authorization to use the display device; determine protocol to display the presentation file on the display device; provide the user with a mechanism to control which section of the presentation file is presented, and to control a format of the presentation; provide the user with a mechanism to control an environment of the meeting room (such as to adjust lighting, air conditioning, etc.); and so forth.

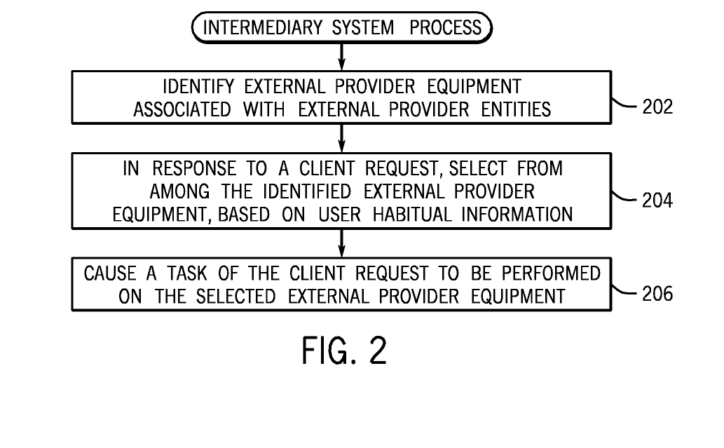

FIG. 2 is a flow diagram of a general process according to some implementations. The process can be performed by the intermediary system 102 of FIG. 1, for example. The process identifies (at 202) the external provider equipment 108 associated with external provider entities that are useable on behalf of client devices. The external provider equipment 108 can include devices to perform various functions (e.g. display function, audio playing function, processing function, etc.), and network connection infrastructure for establishing network connections, including wired and/or wireless connections.

In response to a request from a client device (such as request 104 in FIG. 1), the intermediary system 102 selects (at 204) from among the identified external provider equipment 108 associated with the external provider entities. The selecting can be based on habitual information associated with the user of the client device.

The intermediary system then causes (at 206) a task of the request to be performed on the selected external provider equipment. Note also that the task of the request can also be performed by one or plural ones of electronic devices that are part of the personal grid of the user. The selected external provider equipment can be considered to be added (temporarily for the duration of the task) to the personal grid of the user.

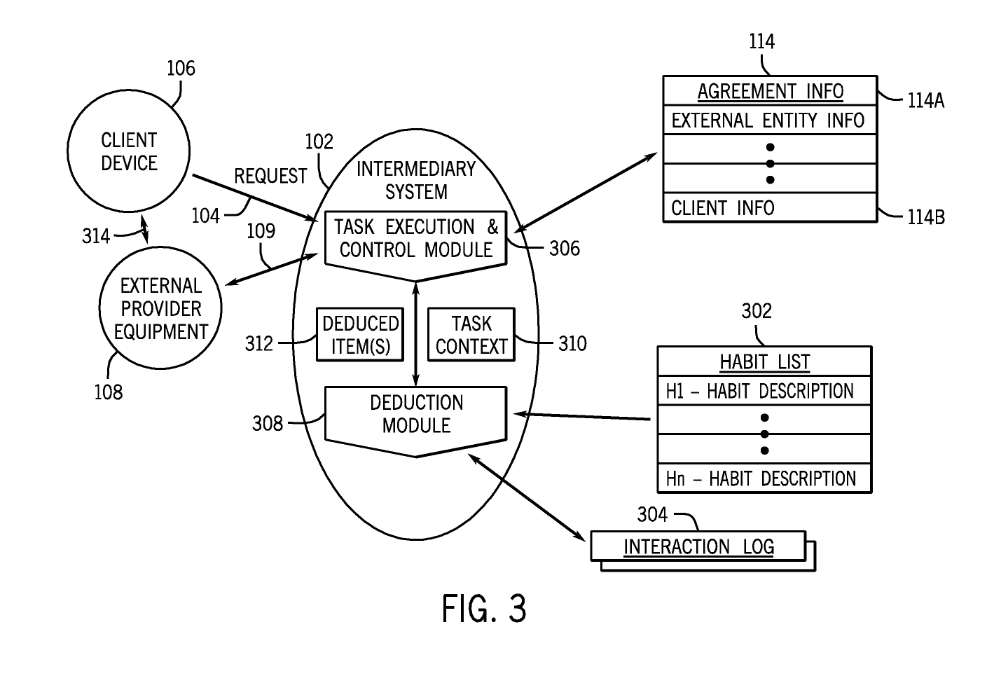

FIG. 3 depicts further details of the intermediary system 102, in accordance with further implementations. In addition, FIG. 3 depicts a habit list 302 (or other type of habit data structure) that contains habitual information of a user, which can refer to information determined based on previous interactions of the user (such as described in an interaction log or interaction logs 304 collected over some time interval). Note that the previous interactions can include activities of the user as well as environmental information collected by client device(s) of the user, as discussed above. The habitual information may also include user preferences, as well as information derived from an agreement between the intermediary service provider and the user of the client device 106.

The habitual information in the habit list 302 can be in the form of habit descriptions (identified as H1, . . . , Hn, respectively). Each habit description can correspond to a particular context in which the respective habit was developed. For example, a first habit description may correspond to previous interactions of the user when making a presentation in a meeting room at a specific location. A second habit description may correspond to previous interactions of the user when playing a music file or video file while traveling.

The intermediary system 102 includes a task execution and control module 306 and a deduction module 308, which can cooperate with each other to perform functionalities of the intermediary system 102 described in this disclosure.

The deduction module 308 can learn from previous user interactions to better understand the habits of the user and to more accurately deduce what the user may prefer as an answer to a client request, or as action(s) to perform in response to the client request. By logging (in interaction logs 304) and analyzing user actions (by the deduction module 308) in various contexts, common elements that occur relatively frequently can be identified and recorded as habit information in the habit list 302. A “context” can refer to an environment in which an interaction is performed, equipment used, a configuration of the equipment, collected environmental information as discussed above, and so forth. By leveraging the habitual information in the habit list 302 in the context of a current task, certain action(s), preferred device(s), preferred network connection(s), and so forth, can be deduced to save the user from having to explicitly specify such action(s), device(s), preferred network connection(s), and so forth.

The task execution and control module 306 informs the deduction module 308 of the context (310) of a task for a client request to be performed. In response to the context (310), the deduction module 308 obtains habitual information from the habit list 202, for this context (310). The deduction module 308 can use the habitual information to select action(s), device(s), network connection(s), and so forth (generally referred to as deduced item(s) 312 in FIG. 3), user for processing the client request.

The selected action(s), device(s), preferred network connection(s), and so forth, can be presented, by the intermediary system 102, to the user at the client device 106, who can modify any of the foregoing if any of the deduced item(s) 312 is not desirable. Effectively, the user can accept or reject any of the deduced item(s) 312. If the user rejects any deduced item 312, then the user may propose a replacement item to use instead.

The deduced action(s), device(s), preferred network connection(s), and so forth, and any responsive user approval or disapproval of any of the deduced action(s), device(s), preferred network connection(s), and so forth, can be logged in the interaction logs 304 for future use by the deduction module 308. The final selection (as confirmed by the user) is used to perform the target task specified by the client request. As depicted in FIG. 2, the client device 106 can directly access (at 314) certain selected external provider equipment. Alternatively, the client device 106 can access selected external provider equipment indirectly via the intermediary system 102.

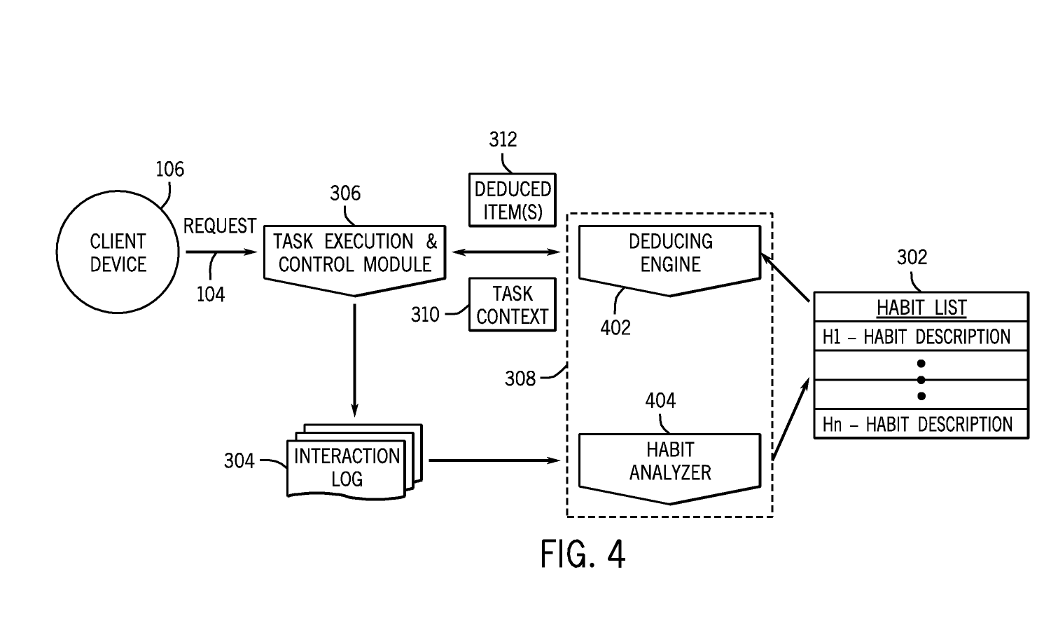

FIG. 4 shows the interactions of various components of the intermediary system 102 in further detail, in accordance with further implementations. Based on execution of a task in response to the request 104 from the client device 106, the task execution and control module 306 logs information (e.g. task name, task state, etc.) relating to the task, including sub-tasks performed, device(s) used, network connection(s) used, and so forth, in the interaction logs 304. The logged information is associated with the corresponding context of the task.

Contextual information regarding the context can include task information (e.g. task name, task state, etc.), external provider domain information (e.g. physical coordinates, meeting type, etc.), equipment information (e.g. type of device(s) used), network connection information (e.g. type of network connection(s) used), and so forth. More generally, the interaction logs 304 can log each interaction between the client device 106 and the intermediary system 102 and/or external provider equipment.

As depicted in FIG. 4, the deduction module 308 includes a deducing engine 402 and a habit analyzer 404. The deducing engine 402 receives the task context 310 from the task execution and control module 306 and accesses the habit list 302 to perform deductions as discussed above in connection with FIG. 3. The deducing engine 402 provides the deduced action(s), device(s), network connection(s), and so forth (deduced item(s) 312) to the task execution and control module 306.

The habit analyzer 404 intermittently (e.g. periodically or in response to predefined events) analyzes the interaction logs 304, and based on the analysis, updates the habit list 302. Although just one habit list 302 is depicted in FIG. 2 or 3, it is noted that there may be additional habit lists in other examples, where each habit list can correspond to a different user, or a different context. The habit descriptions of the habit list 302 can include information provided in a format that is tailored to the corresponding task. Contextual information can also be recorded with the habit descriptions to enable the deducing engine 402 to match the current context (for the task responsive to the request 104) with selected action(s), device(s), network connection(s), and so forth.

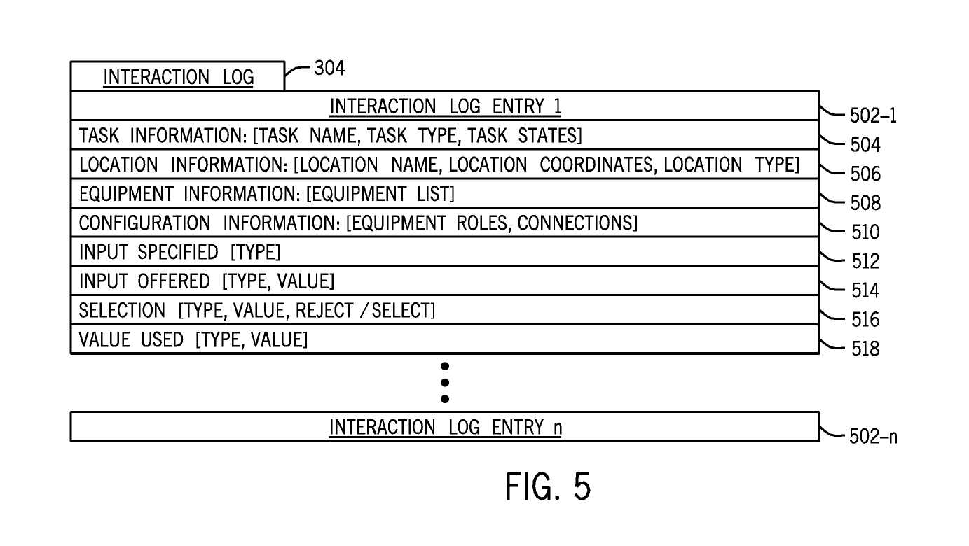

FIG. 5 depicts an example interaction log 304 according to some implementations. The interaction log 304 has various entries 502-1 to 502-n. Each entry 502-i (i=1 to n) can contain the contextual information of a particular interaction involving a client device, which is an interaction associated with a given request of the user. In some examples, the contextual information can be in the context of whether a deduced selection (of an action, device and/or network connection) provided by deduction module 308 was accepted or rejected by the user

Although the following provides various examples of information that can be part of the contextual information, it is noted that other types of contextual information can be provided in other examples. The contextual information can include information (504) about the task that executed in the particular interaction when the deduced selection was accepted or rejected. Examples of the task information can include the task name, the type of task, and the state of the task. The contextual information can also include information (506) about the location of where the deduced selection was accepted or rejected, such as the location name, physical coordinates, and location type.

Furthermore the contextual information can include information (508) about the equipment involved, and information (510) about the configuration of this equipment indicating the connections between different equipment, and the role each piece of equipment in accomplishing a given task.

Further information in the interaction log entry 502-i includes an input specified (512) by the user for the particular interaction, an input offered (514) by the deduction module 308, a selection (516) made in response to the offered input (where the selection can include an acceptance or rejection), and the value(s) (518) actually selected, where the value(s) can refer to the selected action(s), device(s), and network connection(s).

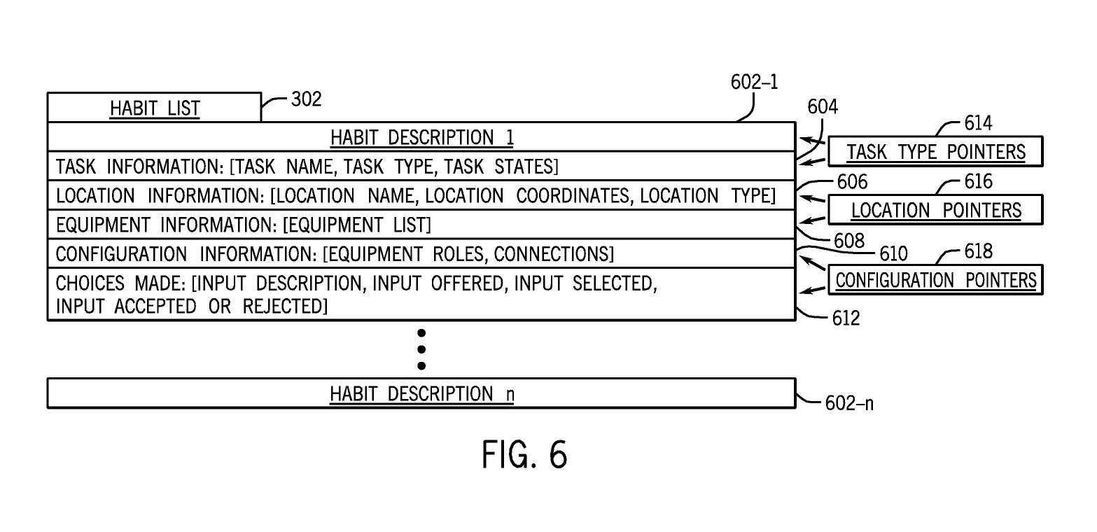

FIG. 6 shows example entries 602-1 to 602-n containing respective habit descriptions that can be created by the habit analyzer 404. As noted above, the habit analyzer 404 reads interaction logs 304 and creates a corresponding habit list 302 and associated pointers. The contextual information (such as those discussed in connection with FIG. 5) of a given interaction is read by the habit analyzer 404 from an interaction log 304 and recorded in an entry 602-i of the habit list 302. For example, the following information can be included in the entry 602-i: task information 604, location information 606, equipment information 608, configuration information 610, and choice information 612 (including an input description, input offered, input selected, and input accepted or rejected, similar to corresponding information 512, 514, 518, and 516 in FIG. 5).

The input description information 512 in an interaction log entry 502-i (of FIG. 5) is transformed to create the input description of the choice information 612 of FIG. 6. Similarly, the input offered information 514 of the interaction log entry 502-i is transformed to create the input offered information of the choice information 612; the value used information 518 of the interaction log entry 502-i is transformed to create the input selected information of the choice information 612; and the input selected information 516 of the interaction log entry 502-i is transformed to create the input accepted or rejected information of the choice information 612.

In addition, various pointers 614, 616, and 618 can be associated with the habit descriptions in the habit list 302. The pointers 614, 616, and 618 are provided to assist the deducing engine 402 to more quickly find relevant habit descriptions for a given request context. The task type pointers 614 correlate each of multiple task types to respective habit descriptions for the corresponding task type. The location pointers 616 correlate each of multiple locations to respective habit descriptions for the corresponding location. The configuration pointers 618 correlate each of multiple different equipment configurations to respective habit descriptions.

In some implementations, a given habit description that is pointed to by a greater number of the pointers 614, 616, and 618 can be considered to provide a higher probability of being a correct selection if accepted, and a lower probability selection if rejected.

The task execution and control module 306 of the intermediary system 102 informs the deduction module 308 of the context of the task. Based on this context, the deduction module 308 can use the pointers 614, 616, and 618 to identify the habit description entries of the habit list 302 that may be relevant to the client task in its present state.

Based on the habitual information identified, the deduction module 308 identifies the most probable item(s), including action(s), device(s), network connection(s), and so forth, that are likely to be preferred by the user in performing the target task. Such identified item(s) is (are) returned to the task execution and control module 306. Information pertaining to the identified item(s) can include device identifiers, file name or path name identifiers, physical location identifiers, program identifiers, people or group identifiers, and so forth.

A variety of techniques could be used to identify the deduced item(s), such as identifying the habit list entries that are pointed to by all three pointers 614, 616, and 618. The most frequently occurring item can be returned, or alternatively all items can be returned with indications of the frequency of each. The items that meet a specified threshold frequency of occurrence can be used as the deduced items returned by the deduction module 308 to the task execution and control module 306.

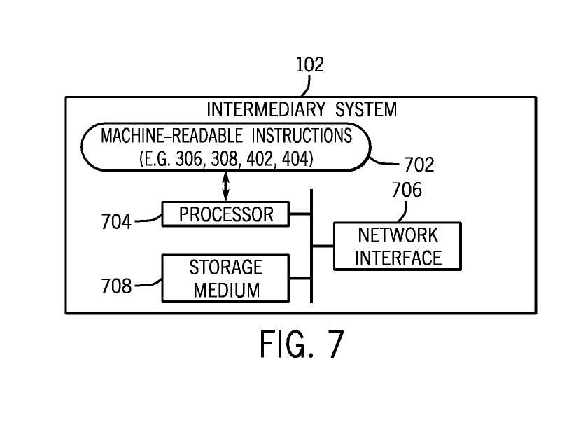

FIG. 7 is a block diagram of an example arrangement of the intermediary system 102 in accordance with some implementations. As noted above, the intermediary system 102 can be implemented with a computer system and any associated intermediary infrastructure at a particular location, or alternatively, the intermediary system 102 can include a distributed arrangement of computer systems and associated intermediary infrastructure at multiple different locations distributed across any geographic region, such as a city, state, country, or the entire world. The intermediary system 102 can run at a central location (different from the client's location), could be part of a machine in the same location as the client, can run on one of the devices in the client's personal grid, or in multiple locations.

The intermediary system 102 includes machine-readable instructions 702, which can include any one or multiple of the following: task execution and control module 306 and deduction module 308 of FIG. 3, deducing engine 402 or habit analyzer 404 of FIG. 4, and so forth. The machine-readable instructions 702 are executable on one or multiple processors 704, which can be coupled to a network interface 706 and a storage medium (or storage media) 708. A processor can include a microprocessor, microcontroller, processor module or subsystem, programmable integrated circuit, programmable gate array, or another control or computing device.

The network interface 706 can include one or multiple network interface controllers to allow the intermediary system 102 to communicate with external devices, such as the client device 106 and external provider equipment 108 of FIG. 1.

The storage medium (or storage media) 708 can be implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
identifying, by an intermediary system, equipment associated with provider entities useable on behalf of a client device;
in response to a request of the client device, selecting, by the intermediary system, from among the identified equipment associated with the provider entities, where the selecting is based on habitual information associated with a user of the client device; and
causing, by the intermediary system, a task of the request to be performed on the selected equipment.

2. The method of claim 1, wherein identifying the equipment comprises identifying devices to perform respective functions and network communication infrastructure to establish respective network connections, and
wherein the selecting comprises selecting from among the devices and the network communication infrastructure.

3. The method of claim 1, further comprising:
collecting previous interactions of the user as interaction log information; and
analyzing the interaction log information to derive the habitual information.

4. The method of claim 3, wherein collecting the previous interactions as the interaction log information comprises associating contextual information of the previous interactions with each entry of the interaction log information.

5. The method of claim 4, wherein the contextual information is at least one selected from among location information, equipment information, and equipment configuration information.

6. The method of claim 5, wherein the habitual information is stored in a habit data structure having a plurality of habit descriptions, the method further comprising associating the contextual information with each of the habit descriptions.

7. The method of claim 6, further comprising associating pointers with the habit descriptions, wherein a particular one of the pointers correlates at least one selected from among a task type, a location, and an equipment configuration with plural ones of the habit descriptions.

8. The method of claim 1, wherein the selecting comprises selecting plural devices associated with respective plural ones of the provider entities to perform sub-tasks of the task.

9. The method of claim 1, further comprising selecting, based on the habitual information, at least one action to perform for the task.

10. The method of claim 1, further comprising presenting a user interface to the client device to allow the user to accept or reject the selected equipment.

11. An intermediary system comprising:
at least one processor to:
generate habitual information of a user based on previous interactions of the user;
store information relating to multiple equipment of external entity providers, the stored information specifying protocols to use for the multiple equipment; and
in response to a request of a client device of the user, select, based on the habitual information, at least one of the multiple equipment to perform a task specified by the request.

12. The intermediary system of claim 11, wherein the stored information further specifies authentication mechanisms for accessing the multiple equipment.

13. The intermediary system of claim 11, wherein the selecting of the at least one of the multiple equipment is further based on a context associated with the request.

14. The intermediary system of claim 11, wherein the at least one processor is to further select, based on the habitual information, from among different network connections to use for the task specified by the request.

15. The intermediary system of claim 14, wherein the at least one processor is to further select, based on the habitual information, at least one action to perform for the task specified by the request.

16. The intermediary system of claim 15, wherein the at least one processor is to present a user interface at the client device to enable:
the user to submit the request; and
the user to accept or reject the selected at least one equipment, the selected at least one network connection, and the selected at least one action.

17. The intermediary system of claim 11, wherein the request of the client device comprises an explicit request submitted by the user or a deduced request derived from information of the user.

18. An article comprising at least one machine-readable storage medium storing instructions that upon execution cause an intermediary system to:
identify equipment associated with provider entities useable on behalf of a client device;
in response to a request of the client device, select from among the identified equipment associated with the provider entities, where the selecting is based on habitual information associated with a user of the client device; and
cause a task of the request to be performed on the selected equipment.

19. The article of claim 18, wherein the instructions upon execution cause the intermediary system to further:
collect previous interactions of the user as interaction log information; and
analyze the interaction log information to derive the habitual information.
